(19) United States
(12) Patent Application Publication
(10) Pub. No.: US 2025/0076540 A1
(43) Pub. Date: Mar. 6, 2025

(54) LAMINATED BODY, OPTICAL DEVICE, IMAGING APPARATUS, AND DISPLAY APPARATUS

(71) Applicant: CANON KABUSHIKI KAISHA, Tokyo (JP)

(72) Inventors: JUNJI KAWASAKI, Kanagawa (JP); SHUHEI YAMAMOTO, Tokyo (JP)

(21) Appl. No.: 18/823,404

(22) Filed: Sep. 3, 2024

(30) Foreign Application Priority Data
Sep. 6, 2023 (JP) 2023-144269

(51) Int. Cl. G02B 1/111; G02B 1/18; G02B 7/14; G02B 27/01

(52) U.S. Cl. CPC G02B 1/111; G02B 1/18; G02B 7/14; G02B 27/0101

(57) ABSTRACT

There is provided a laminated body, having a first member and a second member laminated together, in order above a base material from a side close to the base material. The first member includes fibers and a binder binding the fibers, and gaps are provided in the first member. Also provided is an optical device including the laminated body.

### BACKGROUND OF THE DISCLOSURE

### Field of the Disclosure

The present disclosure relates to a laminated body, an optical device, an imaging apparatus, and a display apparatus.

### Description of the Related Art

A laminated body in which a member including fibers and a binder is provided on a base material is known. To the laminated body, a function, such as a hydrophilic property, an antifouling property, an antibacterial property, a water-resistant property, or a weather-resistant property, can be given according to a user's need. It is also known that, as an optical use, the laminated body is used to reduce unnecessary reflected light termed stray light or scattered light generated in a housing. Japanese Patent Application Laid-Open No. 2020-8843 discusses an optical member including an antireflection film containing deformed fibers in a resin for the purpose of decreasing the reflectance in a housing. Japanese Patent Application Laid-Open No. 2011-64737 discusses an optical system component including a coating film having microparticles of a plurality of types of shapes.

However, properties required for a device and an apparatus are enhanced every day, and a more excellent function is required.

### SUMMARY OF THE DISCLOSURE

According to an aspect of the present disclosure, a laminated body in which a first member and a second member are laminated together, in order above a base material from a side close to the base material. The first member includes fibers and a binder binding the fibers, and gaps are provided in the first member.

Further features of the present disclosure will become apparent from the following description of exemplary embodiments with reference to the attached drawings.

### BRIEF DESCRIPTION OF THE DRAWINGS

FIG. 1 is a schematic diagram illustrating a cross-sectional structure of a laminated body according to an exemplary embodiment.

FIG. 2A is a plan view of a deformed fiber included in the laminated body. FIG. 2B is a cross-sectional view of the deformed fiber.

FIG. 3 is a schematic diagram illustrating a cross-sectional structure of a laminated body according to a variation.

FIGS. 4A to 4E are schematic diagrams illustrating variations of the deformed fiber.

FIG. 5 is a schematic diagram illustrating an exemplary embodiment of an imaging apparatus according to the exemplary embodiment.

FIG. 6 is a schematic diagram illustrating an exemplary embodiment of a display apparatus according to the exemplary embodiment.

FIG. 7 is a cross-sectional image of a laminated body in example 1.

FIG. 8A is a map of an intensity of an X-ray C Kα ray in an energy-dispersive X-ray spectroscopy (EDS) analysis in a cross section of the laminated body in example 1. FIG. 8B is a map of an intensity of an X-ray Si Kα ray. FIG. 8C is a graph illustrating average values in a Z-direction of the intensity of the X-ray Si Kα ray and the intensity of the X-ray C Kα ray, and an intensity ratio between the intensity of the X-ray C Kα ray and the intensity of the X-ray Si Kα ray.

### DESCRIPTION OF THE EMBODIMENTS

To a laminated body according to the present disclosure, a function, such as a hydrophilic property, an antifouling property, an antibacterial property, a water-resistant property, or a weather-resistant property, can be given according to a user's need. The laminated body is also used for an optical use.

In the following disclosure, the optical use is mainly described.

### [Optical Member]

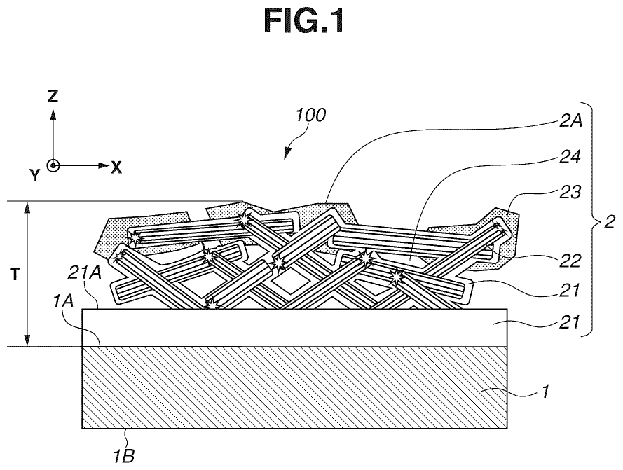

FIG. 1 is a schematic diagram illustrating a cross-sectional structure of a laminated body according to an exemplary embodiment. An optical member (laminated body) 100 as the laminated body includes a base material 1 and an antireflection film 2 provided above the base material 1 and having a light reflection surface 2A. In the antireflection film 2, a first member and a second member are laminated together, in order.

### (Base Material)

The base material 1 includes a first surface 1A, which is a front surface of the base material 1, and a second surface 1B, which is a back surface of the base material 1 that is a surface of the base material 1 on the opposite side of the first surface 1A. Above the first surface 1A of the base material 1, the antireflection film 2 is provided in close contact with the first surface 1A of the base material 1. Above the first surface 1A of the base material 1, a primer layer for increasing the adhesive force with the antireflection film 2 may be provided. The adhesiveness with the antireflection film 2 may be enhanced by increasing the surface roughness of the surface of the first surface 1A of the base material 1.

The material of the base material 1 is not particularly limited, and a metal or a resin can be used. Examples of the metal include aluminum, an aluminum alloy, titanium, a titanium alloy, stainless steel, magnesium, and a magnesium alloy. In terms of cost and durability, it is desirable that the metal should be an aluminum alloy or a magnesium alloy. Examples of the resin include a polycarbonate resin, an acrylic resin, an acrylonitrile butadiene styrene (ABS) resin, and a fluororesin.

### (Antireflection Film)

The antireflection film 2 includes the first member and the second member 23. The first member includes fibers and a binder 21 binding the fibers, and gaps 24 are provided in the first member. In the present exemplary embodiment, the refractive index of the second member 23 is smaller than that of the first member. In the present exemplary embodiment, the binder 21 is provided in close contact with the first surface 1A of the base material 1. As described above, a primer layer may be provided between the base material 1 and the binder 21.

### <Resin>

The binder 21 includes a first surface 21A, which is the surface of the binder 21. The binder 21 can have a plurality of gaps 24. The binder 21 has a function of binding at least parts of the fibers.

The fibers may all be buried in the binder 21.

A material forming the binder 21 is not particularly limited, and an inorganic material or a resin material can be used. Examples of the inorganic material include a silica binder. The resin material can be selected from, for example, an acrylic resin, a urethane resin, an epoxy resin, and the combination of these. The resin material may be either a solvent-soluble resin or a reaction curable resin. It is desirable that the binder 21 should be dyed black using a black dyeing material to increase the absorption efficiency of a ray. In terms of the ease of dyeing the binder 21 black, it is desirable that the binder 21 should be a resin. The type of the black dyeing material is not particularly limited, and the black dyeing material can be selected from, for example, an organic material, such as dyeing ink, metals, such as nickel, cobalt, and copper, and an inorganic material, such as carbon black. “Black” refers to a tint that absorbs the entire range of light wavelengths of 380 nm (nanometers) or more and 780 nm or less. It is desirable that the degree of blackness of the binder 21, which is represented by the ratio of the maximum absorption rate to the minimum absorption rate in the range of light wavelengths of 380 nm or more and 780 nm or less, should be 0.7 or more.

Although the thickness of the binder 21 is not particularly limited, it is desirable that the thickness of the binder 21 should be in the range of 10 μm (micrometers) or more and 700 μm or less. If the thickness of the binder 21 is in this range, it is possible to achieve both an excellent antireflection function and the difficulty of coming off. If the thickness of the binder 21 is smaller than 10 μm, the antireflection function may not be sufficiently obtained. If, on the other hand, the thickness of the binder 21 exceeds 700 μm, film thickness unevenness is likely to occur. If the film thickness unevenness is great, the binder 21 may be likely to come off the base material 1. It is more desirable that the thickness of the binder 21 should be in the range of 20 μm or more and 500 μm or less.

### <Fibers>

The fibers include fibers 22, parts of which bind with the binder 21 and which protrude from the first surface 21A, which is the surface of the binder 21, and fibers that are provided on the protruding fibers 22 and are not in contact with the first surface 21A. The surfaces of the fibers 22 protruding from the first surface 21A are covered by the binder 21, and the surfaces of the fibers that are provided on the protruding fibers 22 and are not in contact with the first surface 21A are also covered by the binder 21. It is desirable that the angle between the length direction of each fiber (the fiber axial direction) and an XY plane parallel to the base material 1 should be less than 30 degrees. The fiber is placed at the above angle, and thereby the antireflection function is increased by setting the proportion of the gaps 24 to a desired proportion. The proportion of the gaps 24 will be described below.

As the fibers, various fibers can be used according to the optical performance used by the antireflection film 2. For example, a fiber can be used of which the shape of a cross section in a direction perpendicular to the fiber axial direction of the fiber is a circle, an ellipse, or a convex polygon of which all the interior angles are smaller than 180 degrees, or a deformed fiber 22 can also be used. Among these, it is desirable to use the deformed fiber 22 in terms of an increase in the antireflection function.

The deformed fiber 22 refers to a fiber other than the fiber of which the shape of a cross section in a direction perpendicular to the length direction (the fiber axial direction) is a circle, an ellipse, or a convex polygon of which all the interior angles are smaller than 180 degrees. In FIG. 1, a plurality of deformed fibers 22 protrudes from the first surface 21A of the binder 21 and surrounds spaces by randomly piling on top of one another such that the angle between the length direction of each deformed fiber 22 and the XY plane parallel to the base material 1 is less than 30 degrees, thereby forming a plurality of gaps 24. To make a ray (stray light) departing from an optical path incident on the antireflection film 2 less likely to return to the optical path, it is important to reflect the ray multiple times in the antireflection film 2 and confine the light. Although the deformed shapes of the fibers alone have the light confinement effect, the presence of the plurality of gaps 24 can further increase the effect. Particularly, even if a high-angle ray of which the angle of incidence exceeds 80 degrees is incident on the first surface 21A of the binder 21, the ray hits the plurality of deformed fibers 22, thereby being less likely to return to the optical path.

It is desirable that the content of the deformed fibers 22 in the first member should be 33 parts by mass or more and 67 parts by mass or less relative to 100 parts by mass of the first member. To make the deformed fibers 22 likely to protrude from the binder 21, it is desirable that the content of the deformed fibers 22 should be 33 parts by mass or more. In terms of an increase in the variety of a manufacturing method described below, it is desirable that the content of the deformed fibers 22 should be 67 parts by mass. It is desirable that the content of the fibers other than the deformed fibers 22 in the first member should be in the range of 40 parts by mass or more and 80 parts by mass or less relative to 100 parts by mass of the antireflection film 2.

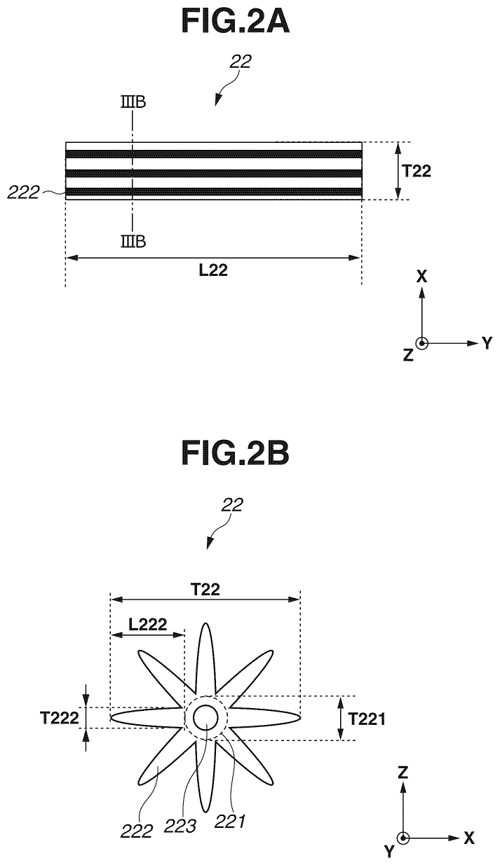

FIGS. 2A and 2B are schematic diagrams of a deformed fiber 22 that can be used in the laminated body according to the present exemplary embodiment. FIG. 2A is a plan view, and FIG. 2B is a cross-sectional view of the deformed fiber 22 along a line IIIB-IIIB in FIG. 2A. The deformed fiber 22 includes a core portion 221, and a plurality of leg portions 222 extending from the core portion 221. The core portion 221 is a portion indicated by a dotted line in FIG. 2B, and a cross section of the core portion 221 is circular. The core portion 221, however, does not necessarily need to be circular, and may be rectangular. If the core portion 221 is a circle, a thickness T221 of the core portion 221 (the length of a cross section in a direction perpendicular to the length direction of the deformed fiber 22) indicates the diameter of the circle. If the core portion 221 is a polygon, the thickness T221 indicates the diameter of the incircle of the polygon. If the core portion 221 is an ellipse, the thickness T221 indicates the diameter of the longer radius of the ellipse. The core portion 221 may include a hole 223.

The leg portions 222 extend from the core portion 221 and are composed of the same material as that of the core portion 221. Although FIG. 2B illustrates eight leg portions 222, the number of leg portions 222 is not limited to eight. It is desirable that in parts of the deformed fiber 22, portions protruding from the first surface 21A of the binder 21 should be the leg portions 222. This is because the plurality of leg portions 222 protrudes from the first surface 21A, thereby diffusing a ray incident between two leg portions 222 and making the ray less likely to return to the optical path. To diffuse a ray between leg portions 222 more efficiently in the deformed fiber 22, it is desirable that the number of leg portions 222 should be three or more and eight or less. Examples of a commercially available deformed fiber having eight leg portions include Octa® manufactured by Teijin Frontier Co., Ltd. It is difficult to manufacture a deformed fiber with nine or more leg portions.

It is desirable that a length L222 of each leg portion 222 should be in the range of 5 μm or more and 20 μm or less. If the length L222 of the leg portion 222 is in this range, a reflectance reduction effect is great. If the length L222 of the leg portion 222 is smaller than 5 μm, the length of the protrusion of the leg portion 222 from the first surface 21A of the binder 21 may be short, light may not be sufficiently reflected between a plurality of leg portions 222, and the reflectance reduction effect may be insufficient. If, in contrast, the length L222 of the leg portion 222 is greater than 20 μm, the leg portion 222 may tilt or collapse, a ray may not be able to sufficiently enter between a plurality of leg portions 222, and the reflectance reduction effect may be insufficient. It is more desirable that the length L222 of the leg portion 222 should be in the range of 5 μm or more and 12.5 μm or less.

It is desirable that a thickness T222 of the leg portion 222 should be in the range of 2 μm or more and 6 μm or less. If the thickness T222 of the leg portion 222 is in this range, the reflectance reduction effect is great. If the thickness T222 of the leg portion 222 is smaller than 2 μm, the leg portion 222 may tilt or collapse, light may not be able to sufficiently enter between a plurality of leg portions 222, and as a result, the reflectance reduction effect may be insufficient. If, in contrast, the thickness T222 of the leg portion 222 is greater than 6 μm, the distance between a plurality of leg portions 222 may be small, light may not be sufficiently reflected between the plurality of leg portions 222, and the reflectance reduction effect may be insufficient.

It is desirable that a length L22 of the deformed fiber 22 should be in the range of 0.2 mm or more and 1.0 mm or less. If the length L22 of the deformed fiber 22 is in this range, the antireflection function increases. If the length L22 of the deformed fiber 22 is shorter than 0.2 mm, the proportion of the protrusion of a cut surface that does not have the antireflection function in the deformed fiber 22 from the first surface 21A of the binder 21 may be great, and the antireflection function may be insufficient. If, in contrast, the length L22 of the deformed fiber 22 is longer than 1.0 mm, it may be difficult to cause the leg portions 222 of the deformed fiber 22 to protrude from the first surface 21A of the binder 21 when the antireflection film 2 is formed. It is possible to set the length L22 of the deformed fiber 22 to a desired length by cutting the deformed fiber 22 using a cutting machine.

It is desirable that the aspect ratio of the deformed fiber 22, which is the ratio of the length L22 to a thickness T22 (L22/T22) of the deformed fiber 22, should be in the range of 4 or more and 100 or less. If the aspect ratio is in this range, it is easy to set the angles between the length directions of the plurality of deformed fibers 22 and the XY plane parallel to the first surface 1A of the base material 1 to less than 30 degrees when the antireflection film 2 is formed. If, however, the aspect ratio is smaller than 4 and the deformed fiber 22 comes close to an isotropic shape, the angles between the length directions of the plurality of deformed fibers 22 and the XY plane parallel to the first surface 1A of the base material 1 are likely to exceed 30 degrees, and the probability that incident light hits a cut surface of the deformed fiber 22 having low antireflection performance increases. Thus, the antireflection performance may be insufficient.

The material of the fibers is not particularly limited, and can be selected from, for example, glass fibers, metal fibers, polyester, nylon, acrylic, polypropylene, rayon, polyethylene, polyurethane, cotton linen, knitting wool, and the combination of these. To improve the performance of the antireflection film 2, working, a light resistance process, a softening process, or a fading resistance process may be performed on the deformed fibers 22.

It is desirable that the deformed fibers 22 should be dyed black using a black dyeing material to increase the absorption efficiency of a ray. In terms of the ease of dyeing the deformed fibers 22 black, it is desirable that the deformed fibers 22 should be selected from polyester nylon, acrylic, polypropylene, rayon, polyethylene, polyurethane, cotton linen, knitting wool, and the combination of these. The type of the black dyeing material is not particularly limited, and the black dyeing material can be selected from, for example, an organic material such as dyeing ink, metals such as nickel, cobalt, and copper, and an inorganic material, such as carbon black.

### <Second Member>

It is desirable that the second member 23 should be a member having a refractive index smaller than that of the first member and closer to the refractive index of air than that of the first member. If the refractive index of the second member 23 is lower than the refractive index of the first member, the reflectance at a low angle of incidence of the antireflection film 2 is lower. The “refractive index” refers to the refractive index in the range of wavelengths of 500 nm or more and 600 nm or less. It is desirable that the refractive index of the second member 23 should be 1.4 or less. It is further desirable that the refractive index of the second member 23 should be 1.35 or less. In the present exemplary embodiment, the second member 23 is provided on the surface of the laminated body on the opposite side of the base material 1. In the form in FIG. 1, the second member 23 is provided more on the upper layer side of the antireflection film 2 to prevent a decrease in the amount of gaps 24. In a case where the total thickness of the first member and the second member 23 is T, a region to a thickness T/2 on the side far from the base material 1 is an upper layer portion, and a region to the thickness T/2 on the side close to the base material 1 is a lower layer portion. At this time, it is desirable that the second member 23 should be more present on the upper layer portion than on the lower layer portion. That the second member 23 is less present on the lower layer portion of the antireflection film 2 means that the number of gaps or the structure of the first member does not change due to the second member 23. Thus, it is also possible to guarantee the function of making the reflectance at a high angle of incidence low that can be achieved by a structure discussed in Japanese Patent Application Laid-Open No. 2020-8843. In this form, since the second member 23 is more present on the upper layer portion of the antireflection film 2, a change in the refractive index at the interface between the antireflection film 2 and an air layer is more gradual. Thus, it is possible to further decrease the reflectance at a low angle of incidence (e.g., an angle of incidence of 45 degrees or less). Fibers present in the upper layer portion of the antireflection film 2 are bound by the binder 21, but include many fibers that are not in contact with the first surface 21A, which is the surface of the binder 21. In other words, many fibers covered by the binder 21 but further placed on other fibers are present. The binding forces of such fibers are weaker than fibers included in the first surface 21A. The second member 23, however, is more present on the upper layer portion of the antireflection film 2, whereby it is possible to reinforce the binding forces of the fibers. It is thus possible to prevent fibers that are not in contact with the first surface 21A, which is the surface of a resin, from coming off.

Thus, in a case where the fibers are the deformed fibers 22, it is possible to increase the content of deformed fibers 22 compared to an antireflection film discussed in Japanese Patent Application Laid-Open No. 2020-8843 and laminate more deformed fibers 22. It is thus possible to further reduce the reflectance.

It is desirable that the thickness of the second member 23 should be in the range of 100 nm or more and 1200 nm or less. It is more desirable that the thickness of the second member 23 should be in the range of 200 nm or more and 800 nm or less. If the thickness of the second member 23 is 200 nm or more, the reflectance reduction effect at a low angle of incidence is more excellent in the optical use. If the thickness of the second member 23 is 800 nm or less, the reflectance reduction effect at high and low angles of incidence is more excellent.

It is desirable that the second member 23 should be transparent. In the present disclosure, “transparent” means that the transmittance of light having a wavelength in the range of 400 nm or more and 780 nm or less is 10% or more.

Although the material of the second member 23 is not particularly limited, it is desirable that the material should be able to form a film by going around to a depression of a deformed fiber 22 (a position between leg portions 222) or a portion where deformed fibers 22 overlap each other. It is further desirable that the material should be able to reinforce the binding force between deformed fibers 22. From this viewpoint, a resin material or a material using inorganic particles can be used. It is desirable to use inorganic particles and a binder. In the material using the inorganic particles, silica and magnesium fluoride can be used. It is more desirable to use silicon oxide particles (hereinafter, “silica particles”), which have a high affinity for a silica binder used to bind inorganic particles and can create a strong bond. As the resin, a fluororesin can be used. Since the fluororesin has an excellent antifouling property, it is also possible to achieve both an optical characteristic and an antifouling property.

Although the shape of each silica particle is not particularly limited, examples of the shape include a true sphere, a cocoon shape, a barrel shape, a disk, a rod-like shape, a needle-like shape, a rectangular shape, and a chain-like shape. To form more gaps and obtain a low refractive index, it is desirable that the shape should be other than a true sphere, such as a hollow particle or a chain-like particle. Among these, it is desirable that the shape of the silica particle should be a hollow particle having a hollow portion within a spherical shell or a chain-like particle that is a hydrophilic particle connected body. In the hollow particle, a gas (a refractive index of 1.0) included in the hollow portion becomes gap portions in the antireflection film 2, whereby it is possible to decrease the refractive index of the second member 23. As the hollow portion, either a single hole or multiple holes can be appropriately selected. As a method for manufacturing the hollow particle, for example, a method discussed in Japanese Patent Application Laid-Open No. 2001-233611 or Japanese Patent Application Laid-Open No. 2008-139581 is possible.

The chain-like silica particle is a particle having silicon dioxide (SiO₂) as a main component. It is desirable that silicon (Si) is 80 atom % or more among the elements except for oxygen. It is more desirable that Si should be 90 atom % or more. If Si is less than 80 atom %, a silanol (Si—OH) group on the surface of the particle that reacts with the silica binder decreases. Thus, the binding force may decrease. Regarding the average particle size of the chain-like particles, it is desirable that the minor axis should be in the range of 10 nm or more and 50 nm or less, and the major axis should be in the range of 60 nm or more and 200 nm or less. The minor axis substantially corresponds to the diameter of a solid particle. If the minor axis is smaller than 10 nm, or if the major axis is smaller than 60 nm, gaps between the chain-like particles are small. Thus, the refractive index may not be sufficiently low. If the minor axis exceeds 50 nm, or if the major axis exceeds 100 nm, the sizes of gaps between the chain-like particles are large. Thus, the binding force between particles may be weak, and as a result, the binding forces of the fibers in the upper layer portion of the antireflection film 2 may be insufficient. The average particle size of particles when solid particles are connected in a chain-like manner is an average Feret's diameter. The average Feret's diameter can be measured by performing image processing on particles observed using a transmission electron microscope image. As the image processing method, commercial image processing, such as Image-Pro Plus (manufactured by Media Cybernetics), can be used. In a predetermined image region, contrast adjustment is appropriately performed, if necessary, and the average Feret's diameter of particles is measured by measuring the particles, whereby it is possible to calculate and obtain the average value. Examples of commercially available chain-like particles include SNOWTEX-OUP, SNOWTEX-UP®, IPA-ST-UP®, and MEK-ST-UP® manufactured by Nissan Chemical Corporation. These silica sols have irregularly curved shapes.

Although the silica binder can be appropriately selected according to the binding force of the film and the environmental reliability, it is desirable to use the silica binder because the silica binder has a high affinity for silica particles and improves the binding force of a porous film. It is more desirable to use a silicate hydrolytic condensation product among silica binders. It is desirable that the weight-average molecular weight of the silica binder should be 500 or more and 3000 or less in terms of polystyrene. If the weight-average molecular weight is less than 500, cracks are likely to occur after curing, and the stability as a coating material also decreases. If the weight-average molecular weight exceeds 3000, the viscosity increases, and therefore, voids within the binder are likely to be non-uniform. Thus, large voids may occur, and the binding force between particles may decrease. It is desirable that the content of the binder should be in the range of 2 mass % or more and 30 mass % or less relative to a low refractive index portion. It is more desirable that the content of the binder should be in the range of 3 mass % or more and 20 mass % or less.

### <Gap Portions>

It is desirable that a porosity indicating the proportion of the gaps 24 in the antireflection film 2 composed of the first member and the second member 23 should be in the range of 50% or more and 90% or less. The method for measuring the porosity will be described below.

If the porosity satisfies the above range, it is possible to make it easier to guarantee the function of making the reflectance at a high angle of incidence of the laminated body low. Although the gaps 24 can be present in the binder 21 and the second member 23, in terms of the ease of manufacturing, it is desirable that the gaps 24 should be formed by the spaces surrounded by the fibers. It is desirable that the maximum circle equivalent diameter of the gaps 24 formed by the spaces surrounded by the fibers should be in the range of 1 μm or more and 200 μm or less. In this range, it is possible to make the adhesive forces of the fibers with the second member 23 sufficient. It is also desirable that the maximum circle equivalent diameter of the gaps 24 formed in the second member 23 should be in the range of 5 nm or more and 100 nm or less. That is, it is desirable that the gaps 24 formed in the second member 23 are smaller than the gaps 24 in the first member formed by the spaces surrounded by the fibers 22.

As described above, in the laminated body according to the present disclosure, a first member and a second member are laminated together, in order above a base material, the first member includes fibers and a binder binding the fibers, and gaps are provided in the first member. Further, if the refractive index of the second member is lower than that of the first member, it is possible to achieve both a light confinement effect at a high angle of incidence, namely an angle of incidence exceeding 80 degrees, by the gaps, and a reflection function at a low angle of incidence by the second member having a low refractive index. It is thus possible to provide a laminated body more excellent in an antireflection function than in the conventional art. Particularly, it is possible to provide an optical member capable of achieving a low reflectance even at a low angle of incidence, namely 45 degrees or less.

### (Variations)

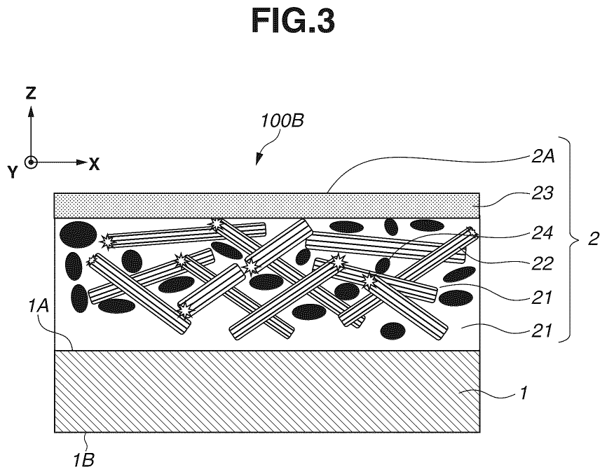

FIG. 3 is a schematic diagram illustrating a cross-sectional structure of a laminated body 100B serving as a variation. The laminated body 100B is different from the laminated body 100 in that fibers are all buried in a binder 21 without protruding from the surface of the binder 21. This configuration is employed, whereby roughness given to a user is reduced, and the design property increases. Instead, gaps 24 are formed in the binder 21. A porous structure (a porous body) may be obtained by using a resin material as the binder 21, or the gaps 24 may be formed by containing hollow particles in a resin material.

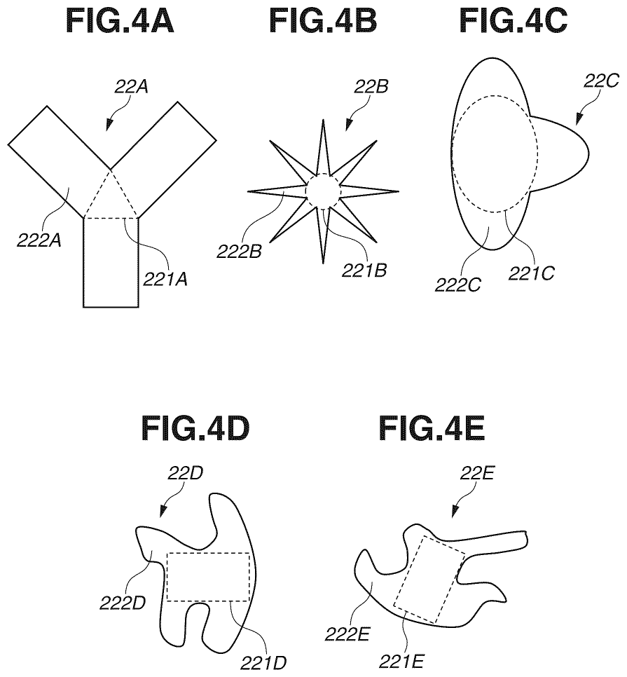

A deformed fiber 22 is not limited to the fiber used in the above exemplary embodiment and having a shape with eight leg portions. FIGS. 4A to 4E are schematic diagrams illustrating variations of the deformed fiber 22.

FIG. 4A illustrates a Y-shaped deformed fiber 22A in which three leg portions 222A extend from a core portion 221A. FIG. 4B illustrates a deformed fiber 22B in which eight sharp-pointed leg portions 222B extend from a core portion 221B. FIG. 4C illustrates a deformed fiber 22C in which three leg portions 222C provided at non-equal distances extend from a core portion 221C.

FIG. 4D illustrates a deformed fiber 22D in which four leg portions 222D that do not have uniform sizes extend from a rectangular core portion 221D in a planar view. FIG. 4E illustrates a cross section of the deformed fiber 22D different from that in FIG. 4D. As described above, all cross sections of the deformed fiber in a direction perpendicular to the length direction do not need to be the same as each other. Examples of a fiber having such a shape include a crimped fiber in which each fiber is crimped and wound. Examples of a commercially available crimped fiber include CALCULO® manufactured by Teijin Frontier Co., Ltd. The forms of these variations also have antireflection functions similar to those in the above exemplary embodiment.

To the laminated body according to the present disclosure, a function such as, a hydrophilic property, an antifouling property, an antibacterial property, a water-resistant property, or a weather-resistant property, can be given according to a user's need. Thus, a second member 23 may be a functional member having a function, such as a hydrophilic property, an antifouling property, an antibacterial property, a water-resistant property, or a weather-resistant property, instead of a member having a low refractive index. On the second member 23, a functional film may further be provided that has a function, such as a hydrophilic property, an antifouling property, an antibacterial property, a water-resistant property, or a weather-resistant property.

### [Method for Manufacturing Laminated Body]

A method for manufacturing the laminated body is not particularly limited, and an example is illustrated below.

For example, a coating material A including a resin material as a precursor of a binder 21 and fibers, and a coating material B including silica particles and a silica binder are prepared. First, the coating material A is applied to a base material 1, and then, the coating material B is applied, whereby a laminated body 100 can be manufactured.

### <Coating Material A>

A coating material A contains fibers, a resin material serving as a precursor of a binder 21, and an organic solvent.

The coating material A is applied and cured, whereby a first member including the binder 21, deformed fibers 22, and gaps 24 can be formed. A description is given below of an example where the deformed fibers 22 suitable as the fibers are used.

It is desirable that the content of the deformed fibers 22 in the coating material A should be 50 parts by mass or more and 200 parts by mass or less relative to 100 parts by mass of a coating material solid content before the deformed fibers 22 are mixed. The “coating material solid content” refers to the entirety of the solid component included in the coating material A, including not only the precursor of the binder 21 but also an additive. If the content of the deformed fibers 22 is smaller than 30 parts by mass, the antireflection function may not be sufficiently obtained. If, on the other hand, the content of the deformed fibers 22 is greater than 200 parts by mass, when the coating material A is applied using a spray gun, the end of a spray nozzle is likely to be clogged up. Even if the antireflection film 2 is formed, the amount of the coating material solid content such as the resin is small. Thus, the binding between the resin and the deformed fibers 22 may be insufficient, and the deformed fibers 22 may be likely to fall off. To make the deformed fibers 22 likely to protrude from the resin, it is desirable that the content of the deformed fibers 22 should be in the range of 50 parts by mass or more and 200 parts by mass or less. If the deformed fibers 22 are also regarded as a part of the solid content, it can be said that the content of the deformed fibers 22 is 33 parts by mass or more and 67 parts by mass or less relative to 100 parts by mass of the coating material solid content.

The resin material contained in the coating material A forms the binder 21 after the coating material A is dried. The type of the resin material is not particularly limited, and can be selected from, for example, an acrylic resin, a urethane resin, an epoxy resin, and the combination of these. The resin material may be either a solvent-soluble resin or a reaction curable resin.

The type of the organic solvent contained in the coating material A is not particularly limited. Examples of the organic solvent include water, a paint thinner, ethanol, isopropyl alcohol, n-butyl alcohol, ethyl acetate, propyl acetate, isobutyl acetate, and butyl acetate. Examples of the organic solvent also include methyl ethyl ketone, methyl isobutyl ketone, propylene glycol monomethyl ether, toluene, xylene, acetone, cellosolves, glycol ethers, and ethers. One type of these solvents may be used, or a plurality of types of the solvents may be used in mixture.

A method for applying the coating material A is not particularly limited, and any normal application method, such as painting with a brush, application using a doctor blade or a bar coater, spray coating, or spin coating, can be employed.

Among these, it is desirable to use the spray application in terms of the excellence of the property of following the shape of the base material 1. A method for curing the coating material A is not particularly limited, either. The coating material A may be dried at a room temperature (e.g., 23° C.±2° C.), or the curing of the coating material A may be promoted by heat, or ultraviolet light may be emitted to the coating material A. It is desirable that the organic solvent should be 5 parts by mass or more and 80 parts by mass or less relative to 100 parts by mass of the coating material A. If the content of the organic solvent is smaller than 5 parts by mass, it may be difficult to form the first member as a thin layer. When the coating material A is applied using a spray gun, a discharge portion of the spray gun may be clogged up, and options for the manufacturing method decrease. If, on the other hand, the content of the organic solvent exceeds 80 parts by mass, the adhesiveness between the base material 1 and the first member may deteriorate. Moreover, when the coating material A is applied using the spray gun, a shear drop may occur. It is desirable that the viscosity of the coating material A should be 10 mPa·s or more and 200 mPa·s or less. If the viscosity of the coating material A is less than 10 mPa·s, the adhesiveness between the base material 1 and the first member may deteriorate. If, on the other hand, the viscosity of the coating material A is greater than 200 mPa·s, it may be difficult to form the first member as a thin layer.

For the purpose of improving the dispersiveness of the deformed fibers 22 in the coating material A, a coating process may be performed on the surfaces of the deformed fibers 22. In the coating process, a surface-active agent, an inorganic salt, or various resins can be used. An example of the process on the surfaces is described. The surfaces of the deformed fibers 22 cut to a desired length are processed using a tannin compound or tartar emetic, thereby generating a tannin compound on the surfaces of the fibers 22. This maintains the excellent conductivity of the flocked surfaces using the water retention ability of the tannin compound. Alternatively, inorganic salts, an inorganic silicon compound, a surfactant, or a mixture of these is attached to the surfaces of the deformed fibers 22. Examples of the tannin compound include natural tannin and synthetic tannin. Examples of the inorganic salts include sodium chloride (NaCl), barium chloride (BaCl₂), and magnesium chloride (MgCl₂). Examples of the inorganic salts also include magnesium sulfate (MgSO₄), silicate soda (Na₂SiO₃), sodium carbonate (Na₂CO₃), and sodium sulfate (Na₂SO₄). Examples of the inorganic silicon compound include colloidal silica. Further, examples of the surfactant include an anionic surfactant, a non-ionic surfactant, an ampholytic surfactant, and a cationic surfactant.

A method for manufacturing the coating material A is not particularly limited, and the deformed fibers 22 only need to be able to be dispersed in the coating material A. The deformed fibers 22 may be put into a container storing the organic solvent, or the organic solvent may be put into a container storing the deformed fibers 22. Examples of the dispersion method include a bead mill, a ball mill, a jet mill, a tri-roller, a planetary rotation apparatus, a mixer, and an ultrasonic dispersion machine.

### <Coating Material B>

A coating material B contains silica particles and a silica binder that is an inorganic particle binder. The coating material B is applied and cured, whereby a second member 23 and gaps 24 can be formed.

A film may be formed with the concentration of the silica particles corresponding to a desired content according to the film thickness required as the second member 23. The concentration can be appropriately selected according to the solvent and the film formation conditions. It is desirable that the concentration of the silica particles should be 3 mass % or more and 20 mass % or less in terms of oxide. If the concentration of the silica particles is 3 mass % or less, an extra layer needs to be added to obtain the required film thickness. If the concentration of the silica particles is 20 mass % or more, particles are likely to aggregate together.

It is desirable that the silica particles should be chain-like particles.

It is desirable that the material of the silica binder should be a material that forms siloxane bonds between the chain-like particles, thereby bonding the particles. A mixture of a solution including a component required to form a binder composed of an alkoxysilane hydrolytic condensation product as the binder and a solution obtained by dispersing the chain-like particles in a solvent may be used. Alternatively, a solution obtained by dispersing solid particles connected in a chain-like manner in a solvent may be applied. After the particles are aligned, the solution including the component required to form the binder may be applied.

As the solution including the component required to form the inorganic particle binder, a solution including an alkoxysilane hydrolytic condensation product can be used. The solution including the alkoxysilane hydrolytic condensation product can be prepared by agitating and reacting alkoxysilane and water, hydrolyzing the alkoxysilane, and generating the alkoxysilane hydrolytic condensation product.

Since the alkoxysilane serving as a precursor of the alkoxysilane hydrolytic condensation product does not dissolve in water, the alkoxysilane and the water are in a two-layer separation state at the early stage of the reaction in a case where the alkoxysilane and the water are mixed together. If the reaction proceeds, alkoxide becomes silanol, and a hydrophilic group increases, whereby an alkoxysilane hydrolysate dissolves in the water layer, the two-layer separation state is resolved, and the alkoxysilane and the water are evenly mixed together.

If the concentration of the alkoxysilane hydrolysate in the water layer is too high, the reaction with the water rapidly proceeds. Thus, gelation may occur, or the viscosity may increase. Accordingly, it is desirable to add 10 mass % or more of a water-soluble solvent to the alkoxysilane as a raw material. The “water-soluble solvent” refers to a solvent in which the solubility of water at 23° C. is 80 mass % or more. It is desirable that the water-soluble solvent should be a cellosolve or a glycol ether. Examples of the water-soluble solvent include 2-methoxyethanol, 2-ethoxyethanol, 2-isopropoxyethanol, 1-methoxy-2-propanol, and 1-ethoxy-2-propanol.

It is desirable that, as the inorganic particle binder used in mixture with the chain-like particles, the liquid temperature of the solution obtained by evenly mixing the alkoxysilane hydrolytic condensation product generated by hydrolyzing the alkoxysilane and the water should be higher than 5° C. and 30° C. or lower. If the liquid temperature of the solution is 5° C. or lower, it takes too much time for the hydrolysis, and the productivity of the alkoxysilane hydrolytic condensation product decreases. If the liquid temperature of the solution is 30° C. or higher, a condensation reaction proceeds, and the alkoxysilane hydrolytic condensation product grows too much. Thus, scattering due to the alkoxysilane hydrolytic condensation product or scattering due to increases in the sizes of gaps formed between the chain-like particles increases, which is not desirable.

The degrees of progress of the hydrolysis and the condensation reaction of the alkoxysilane hydrolytic condensation product can be evaluated based on an average particle. It is desirable that the average particle size of the alkoxysilane hydrolytic condensation product obtained by measuring the solution including the component required to form the inorganic particle binder using a dynamic light scattering method should be 8 nm to 30 nm. It is more desirable that the average particle size of the alkoxysilane hydrolytic condensation product should be 8 nm to 15 nm.

As the alkoxysilane, trifunctional silane modified with a methyl group, such as methyltriethoxysilane and methyltrimethoxysilane, tetrafunctional silane, such as tetraethoxysilane, or a mixture of the trifunctional silane and the tetrafunctional silane may be used. A silanol group is increased, whereby the probability that siloxane bonds are formed at contact points between the particles increases, and the strength of the antireflection film 2 becomes great. Thus, it is particularly desirable to use the tetrafunctional silane.

The concentration of the component required to form the inorganic particle binder can be appropriately selected according to the concentration of the chain-like particles. If the concentration of the component is 0.2 mass % or more and less than 1.5 mass %, a suitable strength for the second member 23 can be obtained, which is desirable. It is further desirable that the concentration of the component should be 0.2 mass % or more and 1.0 mass % or less. If the concentration of the component is less than 0.2 mass %, it is insufficient to bind the particles. Thus, the strength of the film becomes weak. If, on the other hand, the concentration of the component is high, namely 1.5 mass % or more, the component required to form the inorganic particle binder in the particle film is excessive. Then, gaps are filled, and the refractive index becomes high, whereby the antireflection effect decreases.

As a dispersion medium used for the dispersion liquid, a dispersion medium having an excellent affinity for silica particles can be appropriately selected. A dispersion medium having a low affinity for silica particles causes aggregation. If the affinity between the solvent included in the solution containing the component required to form the inorganic particle binder and the component required to form the inorganic particle binder is low, the component required to form the inorganic particle binder does not dissolve. Even if the coating material B disperses or dissolves, aggregation or separation occurs during the formation of the film and causes a bleaching phenomenon. It is desirable to use a dispersion medium and a solvent having a boiling point of 100° C. or higher and 200° C. or lower as the dispersion medium and the solvent. It is necessary to select the solvent according to the hydrophilic property and the hydrophobic property of the surfaces of hollow particles. If the hollow particles are hydrophobized by processing the hollow particles using a silane coupling agent, it is desirable to use a hydrophilic solvent as the solvent included in the solution containing the component required to form the binder. It is desirable to use trifunctional silane modified with a methyl group, such as methyltrimethoxysilane or methyltriethoxysilane as a precursor of the hollow particles. It is desirable that the solution containing the component required to form the binder should include a solvent in which the solubility of water is 10 mass % or less as a solvent in addition to the hydrophilic solvent. It is desirable that the solution containing the component required to form the inorganic particle binder should include 70 mass % or more of the solvent in which the solubility of water is 10 mass % or less. Examples of the solvent in which the solubility of water is 10 mass % or less include 4-methyl-2-pentanol, 2-pentanol, 2-methyl-1-butanol, 3-methyl-1-butanol, and 2-ethyl-1-butanol. The dispersion liquid includes one type or two or more types of these solvents.

As the concentration of the component required to form the binder in the solution containing the component required to form the inorganic particle binder, the film may be formed with a concentration corresponding to a desired content relative to the formed film of the particles. The concentration can be appropriately selected according to the solvent and the film formation conditions.

The second member 23 formed more on an upper layer portion of the antireflection film 2 is formed by applying the coating material B. In the second member 23, a plurality of chain-like particles piles on top of one another on the surface of the second member 23, and the chain-like particles are bonded together by the binder. Due to air (a refractive index of 1.0) included in nanosized gaps, the refractive index of the second member 23 is a refractive index lower than the refractive index of the solid particles themselves connected in a chain-like manner.

A method for applying the second member 23 is not particularly limited, and any normal application method, such as painting with a brush, application using a doctor blade or a bar coater, spray coating, or spin coating, can be employed. To make the reflectance particularly at a low angle of incidence low, it is desirable to use the spray coating. In the spray coating, the concentration of a droplet discharged from a nozzle increases along with the evaporation of the solvent in the air. At this time, the viscosity and the surface tension of the droplet increase. Thus, the second member 23 does not penetrate much into a lower layer portion on the first member side of the antireflection film 2, and it is possible to form the second member 23 in the upper layer portion including a light incident surface.

### [Optical Device and Imaging Apparatus]

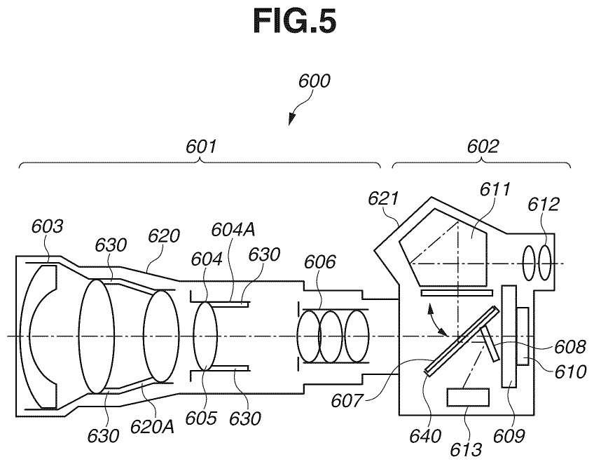

FIG. 5 is a schematic diagram illustrating an exemplary embodiment of the configuration of a single-lens reflex digital camera 600 as an example of an imaging apparatus including a lens barrel serving as an example of a suitable exemplary embodiment of an imaging apparatus according to the present disclosure.

In FIG. 5, a camera main body 602 and a lens barrel 601 as an optical device are joined together. The lens barrel 601 is a so-called interchangeable lens attachable to and detachable from the camera main body 602.

Light from an object passes through an optical system composed of a plurality of lenses 603 and 605 as examples of components placed on the optical axis of an imaging optical system in a housing 620 of the lens barrel 601 and is received by an imaging sensor 610, thereby being captured. The lens 605 is supported by an inner barrel 604 and supported movably relative to an outer barrel of the lens barrel 601 for focusing or zooming. The inner barrel 604 is a supporting body supporting the lens 605.

During an observation period before image capturing, light from an object is reflected by a main mirror 607 serving as an example of a component in a housing 621 of the camera main body 602 and passes through a prism 611, and then, a captured image is displayed to a photographer through a viewfinder lens 612. For example, the main mirror 607 is a one-way mirror, and light passing through the main mirror 607 is reflected in the direction of an autofocus (AF) unit 613 by a sub-mirror 608. For example, this reflected light is used for distance measurement. The main mirror 607 is attached to and supported by a main mirror holder 640 by bonding. The main mirror 607 and the sub-mirror 608 are moved to outside the optical path by using a driving mechanism (not illustrated) when image capturing is performed, a shutter 609 is opened, and an optical image to be captured that is incident from the lens barrel 601 is formed on the imaging sensor 610. A diaphragm 606 is configured to change brightness and the depth of focus in the image capturing by changing the opening area of the diaphragm 606.

To apply the laminated body 100 according to the present disclosure to the lens barrel 601, the housing 620 has the same configuration as that of the base material 1, and an antireflection film 630 having the same configuration as that of the antireflection film 2 is provided on an inner wall surface 620A of the housing 620. Alternatively, the inner barrel 604 has the same configuration as that of the base material 1, and the antireflection film 630 having the same configuration as that of the antireflection film 2 is provided on a first surface 604A of the supporting body, which is the surface of the inner barrel 604 on the side where the lens 605 is supported. This configuration is employed, whereby, among rays incident on the optical device, a ray that does not form an object image without contributing to the formation of an object image hits deformed fibers, thereby being less likely to return to the optical path. As a result, the amount of stray light reaching the imaging sensor 610 is reduced. Based on the imaging apparatus according to the present disclosure, the amount of stray light reaching the imaging sensor 610 is reduced. Thus, it is possible to provide an imaging apparatus that is less likely to cause a flare or a ghost and has an excellent quality of a captured image.

Although the imaging apparatus has been described using a single-lens reflex digital camera as an example, the present disclosure is not limited to this. A smartphone or a compact digital camera may be used.

### <Display Apparatus>

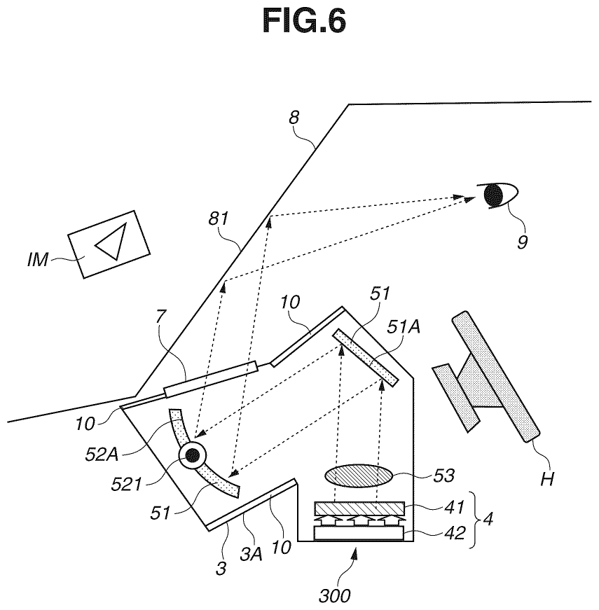

FIG. 6 is a schematic diagram illustrating an exemplary embodiment of the configuration of a head-up display 300 as an example of a suitable exemplary embodiment of a display apparatus according to the present disclosure.

The head-up display 300 is installed in a vehicle, such as an automobile. The head-up display 300 projects video light onto a windshield 8 serving as an example of a display unit, thereby displaying a virtual image IM that can be viewed by a viewer as a driver having an eye 9. The head-up display 300 includes a housing 3, a video generation unit 4, and mirrors 51 and 52. For example, the head-up display 300 is installed in a dashboard in front of a steering wheel H.

The video generation unit 4 is provided within the housing 3. The video generation unit 4 includes a light source 42 and a display panel 41. The light source 42 is a device that emits light, such as a plurality of light-emitting diodes (LEDs). The display panel 41 is a device that modulates the light emitted from the light source 42, thereby generating video light. The display panel 41 is a self-light-emitting display, such as a transmissive liquid crystal display or an organic electroluminescent (EL) display.

The mirrors 51 and 52 are provided within the housing 3. The mirrors 51 and 52 include reflection surfaces 51A and 52A, respectively, and reflect the video light generated by the video generation unit 4 on the reflection surfaces 51A and 52A. The generated video light may pass through an optical path through a condenser lens 53, where necessary, before being reflected by the reflection surface 51A. The mirror 52 has a driving mechanism 521 including a motor and a gear. The angle of the reflection surface 52A can be adjusted by driving the driving mechanism 521 using a control apparatus (not illustrated). Each of the mirrors 51 and 52 is a concave mirror. Each of the mirrors 51 and 52 is obtained by forming a metal film, such as aluminum, on the surface of a base material composed of a resin and having a freeform surface shape. For example, the metal film can be formed by vapor deposition. The video light reflected by the mirror 52 passes through a transmission plate 7, is expanded toward the windshield 8 located outside the housing 3, and is projected.

The transmission plate 7 is, for example, an acrylic plate.

To apply the laminated body 100 according to the present disclosure to the display apparatus, the housing 3 has the same configuration as that of the base material 1, and antireflection films 10 having the same configuration as that of the antireflection film 2 are provided on an inner wall surface 3A of the housing 3. This configuration is employed, whereby a ray generated when a backlight of a head-up display lights up or when outside light is incident, or a ray that is reflected in a housing and does not contribute to the formation of video light hits deformed fibers, thereby being less likely to return to the optical path. As a result, the amount of stray light reaching a display region 81 of the windshield 8 is reduced. Based on the display apparatus according to the present disclosure, the amount of stray light reaching the windshield 8 is reduced. Thus, it is possible to provide a display apparatus having an excellent quality of an image (a virtual image) generated from video light.

Although in the exemplary embodiment of the display apparatus according to the present disclosure, a description has been given using as an example a case where a head-up display is installed in an automobile, the display apparatus is also applicable to another vehicle, such as a train or an aircraft. The display apparatus according to the present disclosure is also applicable to a use other than a vehicle. The display apparatus according to the present disclosure is also applicable to a display apparatus, such as a projector, used indoors or outdoors. Although the antireflection films 10 are provided in three places on the inner wall surface 3A of the housing 3 in FIG. 6, the number and the positions of antireflection films provided in the housing 3 are not limited to this form. Although two mirrors are provided within the housing 3, a single mirror may be provided depending on the design of the optical system.

### EXAMPLES

Prior to examples, first, an evaluation method for evaluating a laminated body in each example is described.

### (Evaluation Method)

### <Reflectance>

The reflectance was measured using an optical member in which an antireflection film was provided on a surface of a polycarbonate resin having a size of 150 mm×70 mm.

The reflectance of the optical member was measured at angles of incidence of 85 degrees and 45 degrees every 1 nm in wavelengths of 500 nm to 600 nm using an ultraviolet-visible near-infrared spectrophotometer (manufactured by JASCO Corporation, product name: V-770), and the average value of the reflectance was determined as the reflectance. The measurements were made after a background correction was performed. At an angle of incidence of 85 degrees, an average reflectance of less than 0.15% was A, an average reflectance of 0.15% or more and less than 0.2% was B, and an average reflectance of 0.2% or more was C. At an angle of incidence of 45 degrees, an average reflectance of less than 0.015% was A, an average reflectance of 0.015% or more and less than 0.02% was B, and an average reflectance of 0.02% or more was C.

### <Strength of Antireflection Film>

The adhesive force of an antireflection film was evaluated by performing a tape test. As a test tape, an adhesive tape defined in Japanese Industrial Standards (JIS) Z 1522 was used. With a surface to which the tape was adhered as a target surface of the test, the torn-off tape was observed using a microscope, and the area of deformed fibers attached to the adhesive surface was evaluated. Specifically, with the evaluated area as a rectangle 2.0 mm long and 1.5 mm wide, the proportion of the total area of the deformed fibers present in the rectangle was observed at five points in each sample, and the average value of the proportion of the total area of the deformed fibers was calculated. If the proportion of the total area of the deformed fibers was less than 0.2%, the adhesive force was A. If the proportion was 0.2% or more, the adhesive force was B.

### <Porosity of Antireflection Film>

The porosity of an antireflection film was measured using an optical member in which an antireflection film was provided on a surface of a polycarbonate resin having a size of 150 mm×70 mm.

In the optical member, a cross section of the antireflection film was cut out using an ion milling apparatus (manufactured by Hitachi High-Tech Corporation., product name: IM4000Plus). The cross section of a sample was observed using a scanning electron microscope (SEM), and an image indicating an area extraction cut by the ion milling in black was acquired. The observation width in an X-direction of the image was 15.8 mm. An uppermost portion 61A of the cut surface of the antireflection film was the film thickness of the antireflection film, thereby obtaining the cross-sectional area of the antireflection film. The proportion of the area of the black portion to the cross-sectional area was subtracted from 100%, thereby obtaining the porosity.

### <Distribution of Second Member of Antireflection Film>

The distribution of a second member (a layer composed of silica particles and a silica binder) in a Z-direction (the film thickness direction) of an antireflection film was measured using an optical member in which an antireflection film was provided on a surface of a polycarbonate resin having a size of 150 mm×70 mm.

### (Manufacturing of Laminated Body)

### Example 1

### <Manufacturing of Coating Material A>

First, a deformed fiber A-1 (manufactured by Teijin Frontier Co., Ltd., product name: Octa) having a cross-sectional shape as illustrated in FIG. 2B was prepared. The deformed fiber A-1 was composed of polyester, a thickness T was 25 μm, the diameter of a core portion was 12.5 μm, eight protruding portions were included, a length CL of each protruding portion was 6.25 μm, and a thickness CT was 3 μm.

Next, the deformed fiber A-1 was cut to a length of 1 mm using a cutting machine. That is, the aspect ratio of the deformed fiber A-1, which is the ratio of the length to the thickness of the deformed fiber A-1, was 40. After being cut, the deformed fiber A-1 was dyed by using a black dye.

The deformed fiber A-1, an acrylic resin, and a paint thinner as an organic solvent were mixed together in a beaker so that the cut deformed fiber A-1 was 50 parts by mass relative to 100 parts by mass of a coating material solid content. To adjust the tint, a delusterant or a colorant, such as carbon black, may be separately added. The mixture was performed using a stirrer, and the resulting product was agitated for 60 minutes at a speed of 200 rpm at a room temperature (23° C.), thereby obtaining a coating material A in example 1.

### <Manufacturing of Coating Material B>

In an isopropyl alcohol (IPA) dispersion liquid of chain-like particles in which silica solid particles are connected together, 1-propoxy-2-propanol (manufactured by Sigma-Aldrich Co. LLC) was substituted for 2-propanol as a solvent by an evaporator, thereby preparing a 1-propoxy-2-propanol dispersion liquid (a solid content concentration of 17 weight %) of the chain-like particles. As the IPA dispersion liquid of the chain-like particles, IPA-ST-UP® manufactured by Nissan Chemical Corporation having a solid content concentration of 15 weight % was used. The ratio of the solvents was 2-propanol:1-propoxy-2-propanol=7.5:92.5.

18.5 g of tetraethoxysilane (TEOS) and 16.0 g of 0.1 weight % phosphinic acid, which was 10 equivalents relative to the TEOS, as catalytic water were added and were mixed and agitated for 60 minutes in a water bath at 20° C., thereby preparing a binder solution 1. Tetraethoxysilane is also termed TEOS or ethyl silicate, and tetraethoxysilane manufactured by Tokyo Chemical Industry Co., Ltd. was used.

32.8 g of the binder solution 1 in which a component required to form a binder was equivalent to 0.5 weight % in terms of oxide was added to 251.3 g of the 1-propoxy-2-propanol dispersion liquid of the chain-like particles. Then, 174.5 g of 1-propoxy-2-propanol and 546.5 g of ethyl lactate were added so that the solid content concentration of the chain-like particles was 4.3 weight % in terms of oxide. Then, the resulting product was agitated for 60 minutes, thereby obtaining a dispersion liquid 1 as a coating material B in which the weight ratio was 1-propoxy-2-propanol:ethyl lactate (having an ether bond or an ester bond, five carbons)=40:60.

### <Manufacturing of First Member and Second Member>

Next, the coating material A was applied onto a polycarbonate resin base material having a size of 150 mm×70 mm using a spray gun (manufactured by Anest Iwata Corporation, product name: W-200).

Then, the polycarbonate resin base material onto which the coating material A was applied was put into a constant-temperature drying oven at a temperature of 100° C. and dried for 120 minutes. Next, the coating material B was applied using a spray onto the surface of the base material onto which the coating material A was applied. To grasp the application film thickness and the refractive index of the coating material B, the coating material B was also applied using the spray onto a silicon substrate (hereinafter, referred to as a “monitor substrate of the coating material B”) under the application conditions for the coating material B. Then, the polycarbonate resin base material onto which the coating materials A and B were applied and the silicon substrate onto which the coating material B was applied were put into the constant-temperature drying oven at a temperature of 120° C. and dried for 30 minutes, thereby obtaining a laminated body in example 1.

The film thickness and the refractive index were measured by measuring an optical element in which an antireflection film was formed on a silicon substrate by using spectroscopic ellipsometry (EC-400 manufactured by J.A. Woollam). The film thickness of a silica particle film was 800 nm, and the refractive index of the silica particle film was 1.24.

Next, the reflectance was measured at an angle of incidence of 85 degrees and an angle of incidence of 45 degrees. The results of the measurements were both A. Then, the adhesive force of the antireflection film was evaluated. The result of the evaluation was A.

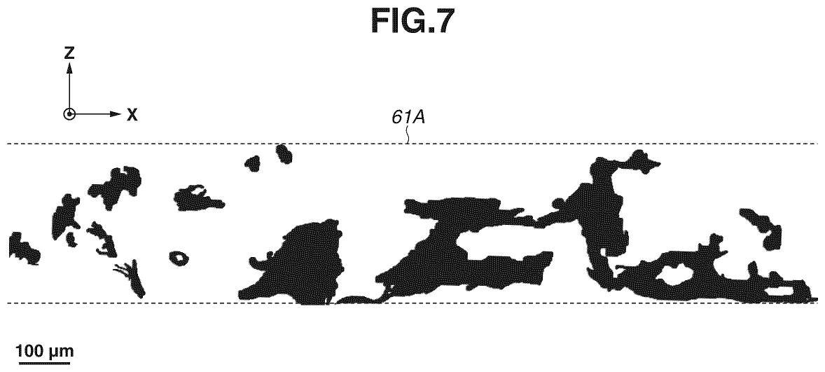

Finally, a cross section of the laminated body was cut out by using the ion milling apparatus. The cross section of a sample was observed by using the SEM, and an image indicating an area extraction cut by the ion milling in black as illustrated in FIG. 7 was obtained. The porosity of this sample was 75%.

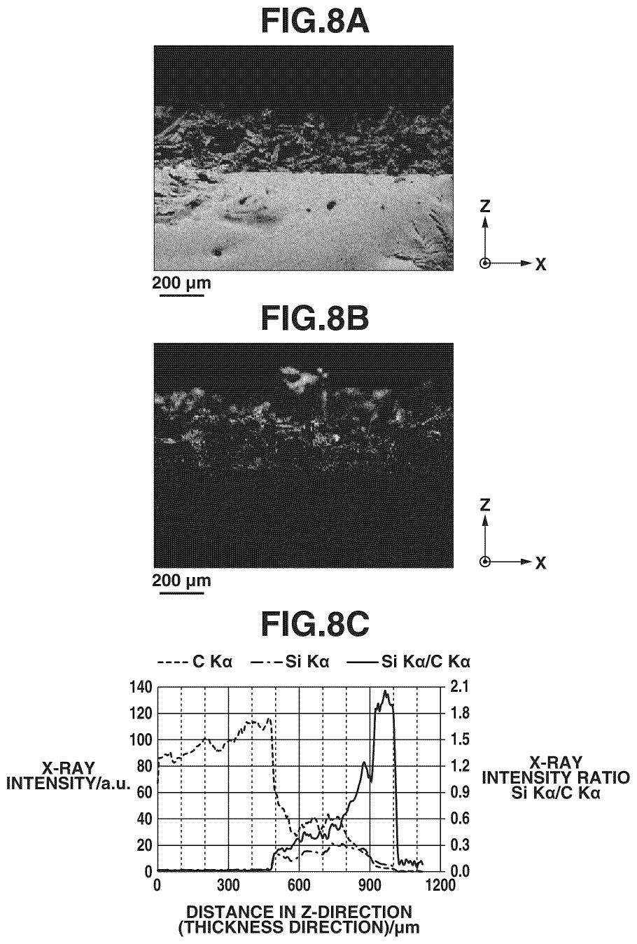

The cross section was also evaluated by performing an energy-dispersive X-ray spectroscopy analysis (an EDS analysis) using a field emission scanning electron microscope. FIG. 8A illustrates a C Kα ray map analysis image (an 8-bit image) in the cross section of the antireflection film. FIG. 8B illustrates a Si Kα ray map analysis image (an 8-bit image) in the cross section of the antireflection film. FIG. 8C illustrates the intensities of the C Kα ray and the Si Kα ray and the intensity ratio Si Kα/C Kα in the film thickness direction. Since the base material is made of polycarbonate, the intensity of the C Kα ray is great, whereas the intensity of the Si Kα ray is zero up to a distance of 500 μm in the Z-direction. The intensity of the C Kα ray sharply decreases and the intensity of the Si Kα ray increases across 500 μm. That is, the position of 500 μm in the Z-direction is the interface between the antireflection film and the base material. The position of 1000 μm where the intensity of the C Kα ray and the intensity of the Si Kα ray are both zero is the surface of the antireflection film. As can be seen from the profile of the intensity ratio Si Kα/C Kα in the Z-direction, the intensity ratio Si Kα/C Kα exceeds 1 in an upper layer portion (900 μm or more) of the antireflection film, whereas the intensity ratio Si Kα/C Kα is less than 0.6 in a lower layer portion (750 μm or less) of the antireflection film. Based on this, it is understood that a second member (a layer composed of the silica particles and the silica binder) having many gaps, namely a porosity of 75%, is unevenly distributed in the upper layer portion of the film.

From the above result, a low reflectance can be achieved at a high angle of incidence with a film composed of deformed fibers having micrometer-sized gaps and a resin. Further, it is considered that a low reflectance is achieved also at a low angle of incidence by laminating a material having a refractive index lower than those of the deformed fibers and the resin on a surface layer of the film. It is considered that the binding forces of the deformed fibers are also increased, and the adhesive force of the film is also reinforced by laminating the material having a low refractive index on the surface layer.

### Example 2

In a laminated body in example 2, the spray application conditions for the coating material B were changed so that the film thickness of the coating material B on the monitor substrate was 200 nm, and the refractive index of the coating material B on the monitor substrate was 1.24. The laminated body was prepared under the same conditions as those in example 1 except for the above conditions. When the reflectance of the optical member in example 2 was measured, the results of the measurements at an angle of incidence of 85 degrees and an angle of incidence of 45 degrees were both A. The evaluation of the adhesive force of the antireflection film was also A.

### Example 3

In a laminated body in example 3, the preparation conditions for the coating material A were changed, and the deformed fiber A-1, an acrylic resin, and a paint thinner as an organic solvent were mixed together in a beaker so that the cut deformed fiber A-1 was 43 parts by mass relative to 100 parts by mass of a coating material solid content. The coating material A was prepared under the same spray application conditions and drying conditions for the coating material A as those in example 1 after that. The coating material B was prepared under the same preparation conditions as those in example 1. The spray application conditions for the coating material B were changed so that the film thickness of the coating material B on the monitor substrate was 400 nm, and the refractive index of the coating material B on the monitor substrate was 1.24. The laminated body was prepared under the same conditions as those in example 1 except for the above conditions. When the reflectance of the optical member in example 3 was measured, the results of the measurements at an angle of incidence of 85 degrees and an angle of incidence of 45 degrees were both A. The evaluation of the adhesive force of the antireflection film was also A.

### Example 4

In a laminated body in example 4, the preparation conditions for the coating material A were changed, and the deformed fiber A-1, an acrylic resin, and a paint thinner as an organic solvent were mixed together in a beaker so that the cut deformed fiber A-1 was 56 parts by mass relative to 100 parts by mass of a coating material solid content. The laminated body was prepared under the same conditions as those in example 3 except for the above conditions. When the reflectance of the optical member in example 4 was measured, the results of the measurements at an angle of incidence of 85 degrees and an angle of incidence of 45 degrees were both A. The evaluation of the adhesive force of the antireflection film was also A.

### Example 5

In a laminated body in example 5, the preparation conditions for the coating material A were changed, and the deformed fiber A-1, an acrylic resin, and a paint thinner as an organic solvent were mixed together in a beaker so that the cut deformed fiber A-1 was 60 parts by mass relative to 100 parts by mass of a coating material solid content. The laminated body was prepared under the same conditions as those in example 3 except for the above conditions. When the reflectance of the optical member in example 5 was measured, the results of the measurements at an angle of incidence of 85 degrees and an angle of incidence of 45 degrees were both A. The evaluation of the adhesive force of the antireflection film was also A.

### Example 6

Example 6 was different from example 1 in that the chain-like silica particles included in the coating material B for forming the second member 23 were changed to hollow silica particles. The coating material B was prepared by the following method.

50 g of 1-ethoxy-2-propanol (hereinafter, referred to as 1E2P) was put into a flask. Then, 200 g of a hollow silica sol (Thrulya 1110 manufactured by JGC Catalysts and Chemicals Ltd.) in which the solid content concentration of hollow particles was 20.5 mass % and a solvent was isopropyl alcohol (hereinafter, referred to as “IPA”) was added into the flask, and 136 g of 1E2P was further added. This mixed liquid was depressurized to 60 hPa, warmed to 45° C., and condensed. After the condensation was continued for 30 minutes, the liquid weight was 205 g. 1E2P, 1-butoxy-2-propanol (hereinafter, “1B2P”), and 2-ethyl-1-butanol (hereinafter, “2E1B”) were added to the liquid obtained by the condensation so that the additive amount ratio was 1E2P:1B2P:2E1B=38:31:31, thereby preparing a diluted solution. This diluted solution was agitated for 30 minutes, thereby obtaining a coating material in which the hollow particles were dispersed. When 5 g of the coating material in which the hollow particles were dispersed was heated to 1000° C., the solid content concentration of the coating material was 3.805 mass %.

The coating material A was prepared under the same preparation conditions and spray application conditions as those in example 3. The spray application conditions for the coating material B were adjusted such that the film thickness of the coating material B on the monitor substrate was 400 nm. Then, the coating material B was applied to a base material on which a film of the coating material A was formed under the same conditions. The refractive index of the coating material B on the monitor substrate was 1.23. When the reflectance of a laminated body in example 6 was measured, the results of the measurements at an angle of incidence of 85 degrees and an angle of incidence of 45 degrees were both A. The evaluation of the adhesive force of the antireflection film was also A.

### Examples 7 to 9

In each of examples 7 to 9, the type of a deformed fiber was changed as illustrated in table 1, and an antireflection coating material and a laminated body were obtained using a method similar to that in example 3. When the reflectance of the laminated body in each example was measured, the results of the measurements at an angle of incidence of 85 degrees and an angle of incidence of 45 degrees were both A. The evaluation of the adhesive force of the antireflection film was also A.

### Examples 10 and 11

In each of examples 10 and 11, the spray application conditions for the coating material B in example 1 were changed, and the film thickness of the coating material B on the monitor substrate was changed as illustrated in table 1. A laminated body was prepared under the same conditions as those in example 1 except for the above conditions. When the reflectance of the laminated body in example 10 was measured, the result of the measurement at an angle of incidence of 85 degrees was A, but the result of the measurement at an angle of incidence of 45 degrees was B. The evaluation of the adhesive force of the antireflection film was A. It is considered that the thickness of a low refractive index portion was thin, and therefore, a reduction in the reflectance at a low angle of incidence was insufficient. When the reflectance of the laminated body in example 11 was measured, the result of the measurement at an angle of incidence of 85 degrees was B, and the result of the measurement at an angle of incidence of 45 degrees was A. The evaluation of the adhesive force of the antireflection film was A. It is considered that if the amount of application of the coating material B was great, the surface shapes of the deformed fibers and gap structures in the antireflection film were changed, and the reflectance at a high angle of incidence was not sufficiently decreased.

TABLE 1

| | | | | Low refractive index | | Reflectance | | |
|---|---|---|---|---|---|---|---|---|
| | | | | portion | | Angle of | Angle of | |
| | Fiber | | | | Film | incidence | incidence of | |
| | Type | | Mass % | Type | thickness/nm | of 85° | 45° | Strength |
| Example 1 | A- | Hollow | 50 | Chain- | 800 | A | A | A |
| | 1 | 8-fin | | like | | | | |
| | | fiber | | | | | | |
| Example 2 | A- | Hollow | 50 | Chain- | 200 | A | A | A |
| | 1 | 8-fin | | like | | | | |
| | | fiber | | | | | | |
| Example 3 | A- | Hollow | 43 | Chain- | 400 | A | A | A |
| | 1 | 8-fin | | like | | | | |
| | | fiber | | | | | | |
| Example 4 | A- | Hollow | 56 | Chain- | 400 | A | A | A |
| | 1 | 8-fin | | like | | | | |
| | | fiber | | | | | | |
| Example 5 | A- | Hollow | 60 | Chain- | 400 | A | A | A |
| | 1 | 8-fin | | like | | | | |
| | | fiber | | | | | | |
| Example 6 | A- | Hollow | 50 | Hollow | 400 | A | A | A |
| | 1 | 8-fin | | | | | | |
| | | fiber | | | | | | |
| Example 7 | A- | Hollow | 50 | Chain- | 400 | A | A | A |
| | 2 | 8-fin | | like | | | | |
| | | fiber | | | | | | |
| Example 8 | A- | Y- | 50 | Chain- | 400 | A | A | A |
| | 3 | shaped | | like | | | | |
| | | nylon | | | | | | |
| | | fiber | | | | | | |
| Example 9 | A- | Crimped | 50 | Chain- | 400 | A | A | A |
| | 4 | fiber | | like | | | | |
| Example 10 | A- | Hollow | 50 | Chain- | 100 | A | B | A |
| | 1 | 8-fin | | like | | | | |
| | | fiber | | | | | | |
| Example 11 | A- | Hollow | 50 | Chain- | 1200 | B | A | A |
| | 1 | 8-fin | | like | | | | |
| | | fiber | | | | | | |
| Comparative | A- | Spherical | 50 | Chain- | 400 | B | B | A |
| example 1 | 5 | nylon | | like | | | | |
| | | fiber | | | | | | |
| Comparative | A- | Hollow | 50 | Absent | | A | C | B |
| example 2 | 1 | 8-fin | | | | | | |
| | | fiber | | | | | | |
| Comparative | A- | Hollow | 43 | Absent | | A | C | B |
| example 3 | 1 | 8-fin | | | | | | |
| | | fiber | | | | | | |
| Comparative | A- | Hollow | 56 | Absent | | A | C | B |
| example 4 | 1 | 8-fin | | | | | | |
| | | fiber | | | | | | |
| Comparative | A- | Hollow | 60 | Absent | | A | C | B |
| example 5 | 1 | 8-fin | | | | | | |
| | | fiber | | | | | | |

The types of deformed fibers are as follows.

(A-1) Hollow 8-Fin Fiber Cross-sectional shape: FIG. 2B, material: polyester, thickness T: 25 μm, diameter of core portion: 12.5 μm, protruding portions: 8, length CL of protruding portion: 6.25 μm, thickness CT of protruding portion: 3 μm

### (A-2) Hollow 8-Fin Fiber

Cross-sectional shape: FIG. 2B, material: polyester, thickness T: 50 μm, diameter of core portion: 25 μm, protruding portions: 8, length CL of protruding portion: 12.5 μm, thickness CT of protruding portion: 6 μm

### (A-3) Y-Shaped Nylon Fiber

Cross-sectional shape: FIG. 4A, material: rayon, thickness T: 20 μm, diameter of core portion: 3 μm, protruding portions: 3, length CL of protruding portion: 9.9 μm, thickness CT of protruding portion: 2.5 μm

### (A-4) Crimped Fiber

Cross-sectional shape: FIGS. 4D and 4E, material: polyester, thickness T: 10 μm, diameter of core portion: 5 μm, protruding portions: 4, length CL of protruding portion: 2.5 μm, thickness CT of protruding portion: 2 μm

### (A-5) Spherical Nylon Fiber

Cross-sectional shape: true circle, material: nylon, thickness T: 10 μm, protruding portions:
absent

### Comparative Example 1

### <Preparation of Coating Material A>

First, a spherical fiber A-5 having a truly circular cross-sectional shape was prepared. The spherical fiber A-5 was composed of nylon, and the thickness T of the spherical fiber A-5 was 10 μm. That is, the diameter in the cross section of the spherical fiber A-5 was 10 μm. Next, after the spherical fiber A-5 was dyed using a black dye, the spherical fiber A-5 was cut to a length of 1 mm using the cutting machine. That is, the aspect ratio of the spherical fiber A-5, which is the ratio of the length to the thickness of the spherical fiber A-5, was 100. The spherical fiber A-5, an acrylic resin, and a paint thinner as an organic solvent were mixed together in a beaker so that the cut spherical fiber A-5 was 50 parts by mass relative to 100 parts by mass of a coating material solid content. To adjust the tint, a delusterant or a colorant such as carbon black may be separately added. The mixture was performed using the stirrer, the resulting product was agitated for 60 minutes at a speed of 200 rpm at a room temperature (23° C.), thereby obtaining a coating material A in comparative example 1.

A laminated body in comparative example 1 was prepared such that the preparation conditions for the base material, the spray application conditions for the coating material A, and other conditions were the same as those in example 3.

When the reflectance of the laminated body in comparative example 1 was measured, the results of the measurements at an angle of incidence of 85 degrees and an angle of incidence of 45 degrees were both B. The evaluation of the adhesive force of the antireflection film was A.

### Comparative Examples 2 to 5

In each of comparative examples 2 to 5, a coating material B was not applied. The proportion of the parts by mass of the deformed fiber A-1 of the coating material A in each comparative example relative to 100 parts by mass of the coating material solid content was changed as illustrated in table 1, and the coating material A was applied using a method similar to that in example 3, thereby obtaining a laminated body. When the reflectance of the optical member in each comparative example was measured, the result of the measurement at an angle of incidence of 85 degrees was A, but the result of the measurement at an angle of incidence of 45 degrees was C. The evaluation of the adhesive force of the antireflection film was B.

As described above, in the laminated body according to the present disclosure, a first member and a second member are laminated together, in order above a base material from the side close to the base material, the first member includes fibers and a binder, and gaps are provided in the first member. Further, if the refractive index of the second member is lower than that of the first member, it is possible to achieve both a light confinement effect at a high angle of incidence, namely an angle of incidence exceeding 80 degrees, by gap portions, and a reflection function at a low angle of incidence by a low refractive index portion. Thus, it is possible to provide a laminated body more excellent in an antireflection function than in the conventional art. Particularly, it is possible to provide an optical member capable of achieving a low reflectance even at a low angle of incidence, namely 45 degrees or less.

The present disclosure is not limited to the above exemplary embodiments, and can be modified in many ways in the technical idea of the present disclosure. The effects described in the exemplary embodiments are merely a list of the most suitable effects provided by the present disclosure, and the effects of the present disclosure are not limited to those described in the exemplary embodiments.

Although the use of an optical member has been mainly described in the disclosure, the use of the laminated body is not limited to an optical use. To the laminated body, a function such as a hydrophilic property, an antifouling property, an antibacterial property, a water-resistant property, or a weather-resistant property can be given. It is possible to use the laminated body not only in an optical device, but also in housings and exteriors of a variety of articles, such as an electronic device, a structural body, and a building.

According to the above method for solving the issue, for example, it is possible to provide a laminated body having a function higher than that in the conventional art.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-144269, filed Sep. 6, 2023, which is hereby incorporated by reference herein in its entirety.

What is claimed is:

1. A laminated body in which a first member and a second member are laminated together, in order above a base material from a side close to the base material,
wherein the first member includes fibers and a binder binding the fibers, and gaps are provided in the first member.

2. The laminated body according to claim 1, wherein a refractive index of the second member is lower than a refractive index of the first member.

3. The laminated body according to claim 1, wherein when a total thickness of the first member and the second member is T, an amount of gaps in a region to a thickness T/2 on a side far from the base material is greater than an amount of gaps in a region to the thickness T/2 on a side close to the base material.

4. The laminated body according to claim 1, wherein gaps are provided in the second member.

5. The laminated body according to claim 4, wherein a porosity of the first member and the second member is in a range of 50% or more and 90% or less.

6. The laminated body according to claim 1,
wherein ends of the fibers protrude from the binder binding the fibers, and
wherein the gaps in the first member are formed by spaces between the fibers.

7. The laminated body according to claim 4, wherein a maximum circle equivalent diameter of the gaps in the second member is smaller than a maximum circle equivalent diameter of the gaps in the first member.

8. The laminated body according to claim 1, wherein the second member is composed of a fluororesin.

9. The laminated body according to claim 1,
wherein the second member is transparent, and
wherein the fibers and the binder binding the fibers are black.

10. The laminated body according to claim 1, wherein the second member comprises inorganic particles and a binder binding the inorganic particles.

11. The laminated body according to claim 10,
wherein the inorganic particles are silicon oxide particles, and
wherein the binder binding the inorganic particles is a silica binder.

12. The laminated body according to claim 11, wherein the silicon oxide particles are chain-like particles or hollow particles.

13. The laminated body according to claim 1, wherein the fibers are deformed fibers, each having a core portion and a plurality of protruding portions extending from the core portion.

14. The laminated body according to claim 13, wherein a content of the deformed fibers in the first member is in a range of 33 parts by mass or more and 67 parts by mass or less.

15. The laminated body according to claim 1, wherein the binder binding the fibers is at least one of an acrylic resin, a urethane resin, and an epoxy resin.

16. The laminated body according to claim 1, wherein the base material comprises at least one material selected from a group consisting of aluminum, titanium, stainless steel, a magnesium alloy, a polycarbonate resin, an acrylic resin, an acrylonitrile butadiene styrene (ABS) resin, and a fluororesin.

17. The laminated body according to claim 1, further comprising a primer layer between the base material and the first member.

18. An optical device including the laminated body according to claim 1, the optical device comprising:
a housing; and
an optical system provided in the housing and including at least one lens,
wherein the base material is a supporting body supporting the lens and/or the housing, and
wherein the first member and the second member are laminated together, in order on a surface of the supporting body supporting the lens and/or an inner wall surface of the housing.

19. An imaging apparatus including the laminated body according to claim 1, the imaging apparatus comprising:
a housing;
an optical system provided in the housing and including at least one lens; and
an imaging sensor configured to receive light having passed through the optical system,
wherein the base material is a supporting body supporting the lens and/or the housing, and
wherein the first member and the second member are laminated together, in order on a surface of the supporting body supporting the lens and/or an inner wall surface of the housing.

20. A display apparatus including the laminated body according to claim 1, the display apparatus comprising:
a housing;
a video generation unit provided in the housing and configured to generate video light; and
a mirror provided in the housing and configured to reflect the video light emitted from the video generation unit and project the video light onto a display unit,
wherein the base material is the housing, and
wherein the first member and the second member are laminated together, in order on an inner wall surface of the housing.
